(19) United States
(12) Patent Application Publication
(10) Pub. No.: US 2024/0429781 A1
(43) Pub. Date: Dec. 26, 2024

(54) Vibrating plate compactor for compacting earth, soil or substrate, and method for operating the same and system

(71) Applicant: Hilti Aktiengesellschaft, Schaan (LI)

(72) Inventor: Uwe BEHRINGER, Marktoberdorf (DE)

(21) Appl. No.: 18/735,697

(22) Filed: Jun. 6, 2024

(30) Foreign Application Priority Data
Jun. 20, 2023 (EP) 23180288.5

(51) Int. Cl. H02K 7/06; E01C 19/40; E02D 3/046; H02K 7/116

(52) U.S. Cl. CPC H02K 7/061; E01C 19/402; E02D 3/046; H02K 7/116

(57) ABSTRACT

A vibrating plate compactor for compacting earth, soil or substrate, for example on a construction site, wherein the vibrating plate compactor has an electric motor which can be operated in a speed range of more than 12,000 revolutions per minute. A method for operating such a vibrating plate compactor, and to a system including such a vibrating plate compactor and a power tool powered by a rechargeable battery. Both the vibrating plate compactor and the power tool can be supplied with electrical power using the same type of power supply device. Using the invention, different devices on a construction site can be supplied with electrical power more easily, and a vibrating plate compactor with a compact drive unit and small transport size can be provided, in which the compaction result can be improved by an ingenious arrangement of the components and the propulsion can be made faster.

This claims priority to European Patent Application EP23180288.5, filed on Jun. 20, 2023 and which is hereby incorporated by reference herein.

The invention relates to a vibrating plate compactor for compacting earth, soil or substrate, for example on a construction site, wherein the vibrating plate compactor has an electric motor. A second aspect of the invention relates to a method for operating such a vibrating plate compactor, and to a system comprising such a vibrating plate compactor and a power tool powered by a rechargeable battery.

### BACKGROUND OF THE INVENTION

In the prior art, soil compaction devices and vibrating plate compactors for compacting earth, soil or substrate, for example on a construction site, are known. These soil compaction devices or vibrating plate compactors usually have a base plate that is excited into vibration or shaking movements for compacting earth, soil or substrate. The vibrations or shaking movements are usually generated by a motor driving a shaft with an eccentric mass, wherein this movement of the shaft is transmitted directly or indirectly, for example via a belt drive, to the base plate. The soil compaction devices or vibrating plate compactors are usually controlled by means of a control electronics which can be connected to the motor and/or the power supply device.

### SUMMARY OF THE INVENTION

Different drive variants are known in the prior art for soil compaction devices and vibration plate compactors. Devices with internal combustion engines, for example, are widely used. In addition, soil compaction devices and vibrating plate compactors with electric motors are known that are supplied with electrical power via a mains connection or by means of power supply devices, such as batteries or accumulators (rechargeable batteries). Due to the typically large weight of the base plates of the soil compaction devices or vibrating plate compactors, high electrical power levels are required to set the floor plate into vibration. Such a power level for driving a base plate of a soil compaction device or a vibrating plate compactor can be in a range between 1,000 and 3,000 watts (1-3 kW), for example. In order to meet this power demand, power supply devices with comparatively large capacities are often used. Thus, a disadvantage of such power supply devices as are used in conventional soil compaction devices and vibrating plate compactors is that they are often incompatible with power tools, such as cordless screwdrivers, hammer drills, core drills or angle grinders, without being limited to these. This means that multiple different types of power supply devices must be made available on a construction site in order to operate both power tools used on a construction site, and soil compaction devices or vibrating plate compactors.

An object of the invention is thus to simplify the power supply of different devices that are used on a construction site.

In order to drive the base plate of the soil compaction devices or vibrating plate compactors, motors with a large installation space are often used, which usually have a speed in a range between 3,000 and 6,000 revolutions per minute (rpm). In addition, the “large” motors often have high weight and volume. The motor, the power supply, the control electronics and the transmission unit for transmitting the movement to the base plate often form a drive unit of a soil compaction device or a vibrating plate compactor. The size of this drive unit essentially determines the transport size and the ground clearance of the soil compaction device or vibrating plate compactor. Due to the large volume and weight of the motors that are normally used in soil compaction devices and vibration plate compactors, this often results in a large, voluminous and heavy drive unit for the soil compaction device or the vibration plate.

A further object of the invention is thus to provide a soil compaction device or vibrating plate compactor which has a comparatively light and compact, i.e. space-saving, drive unit.

Due to the unmanageability and the large volume and weight of the drive units of conventional soil compaction devices and vibrating plate compactors, there is often little scope to optimize the distribution of the weight of the individual components of the soil compaction device or vibrating plate compactor in the direction of an improved compaction result. In other words, a rigid predetermined arrangement of the components often results, in order to be able to arrange all the necessary components of the device on the base plate at all.

A further aim of the invention is thus to provide a soil compaction device or vibrating plate compactor, in which the compaction result can be optimized by an ingenious arrangement of the components of the soil compaction device or the vibrating plate compactor. In addition, it would be welcomed by persons skilled in the art if the arrangement to be provided could also allow a faster propulsion of the soil compaction device or vibrating plate compactor.

Such vibration plate compactors or soil compaction devices are described, for example, in U.S. Pat. No. 9,580,879 B1, U.S. Pat. No. 2,019,078 282 A1, WO 2022 184 666 A1, WO 2022 184 668 A1, WO 2022 184 697 A1, WO 2023 009 800 A1 or WO 2023 009 812 A1.

An object on which the present invention is based is to overcome the deficiencies and disadvantages of the prior art described above and to provide a soil compaction device or vibrating plate compactor with a simplified power supply, wherein the soil compaction device or vibrating plate compactor should have a comparatively lightweight and compact drive unit and in which the compaction result should be optimized and the propulsion improved.

The present invention provides a vibrating plate compactor for compacting earth, soil or substrate, for example on a construction site. The vibrating plate compactor has an electric motor, wherein the electric motor can be operated in a rotational speed range of more than 12,000 revolutions per minute. In the context of the invention, such a motor is preferably referred to as a “fast-rotating electric motor”. In particular, a small transport size and a larger optimization range in the weight distribution of the vibrating plate compactor can be ensured and a vibrating plate compactor with a small, compact drive unit can be provided. This is so because by using an electric motor which is operated at a speed of more than 12,000 revolutions per minute (rpm), a particularly easy-to-handle and compact electric motor can be used in the vibrating plate compactor. This allows the low transport size and the optimization range in the weight distribution of the components of the vibrating plate compactor to be achieved.

It is preferable in the context of the invention that the vibrating plate compactor has a drive unit, wherein the drive unit comprises the electric motor and a control electronics and can be connected to a power supply unit in order to be supplied with electrical power, wherein the control electronics and/or the power supply unit are arranged within the drive unit behind the electric motor. The control electronics and the power supply unit can form a unit, wherein the unit consisting of the control electronics and the power supply unit is preferably located behind the electric motor, i.e. in a rear section of the drive unit. The power supply unit may comprise at least one individual accumulator; however, it is preferred that the power supply unit comprise two individual accumulators.

It is preferred in the context of the invention if the vibrating plate compactor can be provided with a particularly compact drive unit, in which the at least one power supply device is not arranged on the top of the motor, but behind the motor of the vibrating plate compactor. An example of such a refinement of the invention is illustrated in FIG. 3. It is preferred in the context of the invention that the at least one power supply device be arranged in a rear, lower region of the drive unit. In the context of the invention this preferably means that the heavy components of the vibrating plate compactor, such as the motor and power supply devices, are provided in a lower region of the drive unit, i.e. physically close to the base plate. As a result, the drive unit can be designed to be particularly compact. In particular, a drive unit with a particularly small height can be provided, so that the vibrating plate compactor allows a surprisingly low ground clearance of the drive unit or vibrating plate compactor to be achieved. In addition, the centre of gravity of the vibrating plate compactor can be shifted downwards, i.e. in a downward spatial direction or in the direction of the substrate to be processed, compared to conventional vibrating plate compactors as are known from the prior art. This low centre of gravity of the vibrating plate compactor or drive unit allows good handling of the vibrating plate compactor for the user. In addition, tests have shown that the compaction result of the vibrating plate compactor can be improved by shifting the centre of gravity of the vibrating plate compactor in a “downward” spatial direction.

In the context of the invention it is preferred that in the vibrating plate compactor, the drive unit has a motor, a set of electronics and at least one power supply device, wherein the motor is arranged in a front lower region of the drive unit and thus in front of the electronics and/or the power supply device, while the electronics and the at least one power supply device may be provided behind the motor, i.e. in a rear section of the drive unit. The control electronics may preferably be arranged on an upper side of the at least one power supply device, i.e. above the at least one power supply device. Accordingly, the at least one power supply device can be arranged below or on an underside of the control electronics. It is preferred within the context of the invention that the motor, the control electronics and the at least one power supply device are referred to as “components of the drive unit”. The arrangement of the components of the drive unit, as shown in FIG. 3, with the motor in front of the battery and the control electronics above the battery, is preferably referred to as “horizontal arrangement of the components of the drive unit” within the context of the invention. It is preferred within the context of the invention that the components of the drive unit be connected to one another with cables for data, signals and/or electrical power. Preferably, individual regions of these connections can be designed wirelessly.

Of course, two or more power supply devices can be provided in the drive unit instead of the at least one power supply device. In this case, the two or more power supply devices may be arranged behind the motor, for example side by side or one above the other. It is preferred within the context of the invention that the at least one power supply device can be inserted into the drive unit of the vibrating plate compactor in a spatial direction from the rear or from the side in order to supply the vibrating plate compactor with electrical power. In the case of the insertion direction “from behind”, the power supply devices can be very well protected against dirt, moisture or dirty water, whereas in the sideways insertion direction, particularly good accessibility of the receiving regions for the power supply devices is ensured. By the preferably “horizontal arrangement” of the components of the drive unit, a particularly compact drive unit or vibrating plate compactor with a low ground clearance can be provided, wherein the space saved allows a series of improved arrangement options of the components of the vibrating plate compactor, which in particular can also improve performance or operating parameters.

In the context of the invention, it may also be preferred that the power supply device be inserted into the drive unit of the vibrating plate compactor in a spatial direction “from above”. In this case, the power supply device can be inserted into the drive unit of the vibrating plate compactor, for example, in such a way that the insertion direction of the power supply device and a ground plane or substrate plane on which the vibrating plate is placed or which is being processed by the vibrating plate compactor, substantially enclose a right angle of 90°. In other words, the insertion direction and a ground or substrate plane of the vibrating plate compactor can be positioned substantially perpendicular to each other. In the context of the invention, it may also be preferred that the at least one power supply device be inserted into the drive unit of the vibrating plate compactor at an angle. For example, the at least one power supply device can be inserted into the drive unit of the vibrating plate compactor obliquely in a spatial direction “from above”. In this case, the insertion direction of the at least one power supply device may enclose an angle a with the ground or substrate plane of the vibrating plate compactor, wherein the angle a can be between 0 and 180°. Depending on the measurement method, angles in a range between 45 and 135° between the insertion direction and the ground or substrate plane may be preferred. An angle b, which is formed between the insertion direction of the battery and a vertical to the ground or substrate plane, is then preferably around +/−45°. Analogously, the at least one power supply device can be inserted into the drive unit of the vibrating plate compactor at an angle to a spatial direction “from behind” or to the side.

Another advantage of the invention is that a soil compaction device or vibrating plate compactor can be operated with a motor, wherein the motor has rotation speeds in a range that are customary for power tools such as those used on construction sites. For example, such speeds can range from 15,000 to 20,000 revolutions per minute. This allows commercially available motors to be installed in the vibrating plate compactor, which are available on the market in large numbers and at reasonable prices. In this way, a particularly cost-effective vibrating plate compactor can be provided. In addition, the maintenance and repair of the motors of the vibrating plate compactor can be greatly simplified, along with the procurement of spare parts. It is preferred within the context of the invention that electric motors with rotation speeds of more than 12,000 rpm are referred to as “high-speed motors”. In the context of the invention it is preferable that the electric motor is a brushless DC motor.

In addition, the vibrating plate compactor can be offered at a reasonable price, as more cost-effective standard components can be installed compared to conventional soil compaction devices or vibrating plate compactors. This applies in particular to the electric motor, since a commercially available electric motor for a power tool can be used as the electric motor. It was completely surprising that commercially available electric motors for power tools can be used to operate a vibrating plate compactor. Up to now, persons skilled in the art had always assumed that particularly slow-rotating electric motors with speeds in a speed range between 3,000 and 6,000 rpm had to be used to operate a vibrating plate compactor. By using a comparatively small power tool motor with a comparatively high rotational speed in a range of more than 12,000 rpm, a soil compaction device or vibrating plate compactor can be provided with a comparatively lightweight and compact drive unit. In addition, fast-rotating motors, as used in the context of the present invention, are particularly well able to meet the robustness requirements resulting from the use of the vibrating plate compactor in a demanding environment, such as a construction site.

Another advantage of the invention is that a soil compaction device or vibrating plate compactor can be provided with improved compaction results and faster propulsion. These advantages are achieved in particular by the use of a fast-rotating electric motor, as well as the ingenious arrangement of the components within the drive unit of the vibrating plate compactor. The vibrating plate compactor preferably represents a complex multi-component system with elastically coupled masses, which has been optimized in the context of the present invention in such a way that, for example, particularly good compaction results can be achieved.

It is preferred in the context of the invention that the vibrating plate compactor has a spur gearing, wherein the spur gearing is provided in a power train of the vibrating plate compactor following the electric motor. In the context of the invention, it is preferred that the spur gearing be arranged on a drive side of the power train. For example, a sequence of components in the power train can be as follows:
Electric motor—spur gearing—eccentric shaft—base plate.

Preferably, a rotational movement of the electric motor can be converted by means of the spur gearing and/or the eccentric shaft into an oscillation or vibration movement of the base plate of the vibrating plate compactor. This oscillation or vibrational movement of the base plate allows the soil below the base plate of the vibrating plate compactor to be compacted.

The use of a spur gearing enables the use of a fast-rotating electric motor with a rotation speed in a range of more than 12,000 rpm and ensures particularly good integration into the power train of the vibrating plate compactor. This is because the fast-rotating electric motor used in the vibrating plate compactor in the context of the present invention can be designed to be particularly compact or with a small volume for the same power. In particular, a high-speed motor with transmission can be designed significantly smaller than a low-speed motor with the same power. The low-speed motors are used in particular in petrol-powered vibrating plate compactors as are known from the prior art. With the combination of fast-rotating electric motor and spur gearing, an efficient and powerful drive for a vibrating machine can be provided with the invention, which overcomes the disadvantages of the prior art, has a compact drive unit and is optimized for cordless working on a construction site.

It is preferred in the context of the invention that the spur gearing have a single-stage design. The spur gearing can preferably have a transmission ratio in a range between 2.5 and 6. Preferably, the eccentric shaft in the power train of the vibrating plate compactor is operated with a rotational frequency in a range between 90 and 100 Hz. In order to achieve this rotational frequency, according to the invention, a transmission ratio in a range between 2.5 and 6 is preferably used.

In the context of the invention, it is preferred that the vibrating plate compactor be connectable to at least one power supply device in order to be supplied with power. In the context of the invention, it is most particularly preferred that the vibrating plate compactor be connectable to two power supply devices. In other words, the vibrating plate compactor can be connected to two power supply devices or batteries or accumulators (rechargeable batteries) in order to be supplied with electrical power. The power supply devices of the vibrating plate compactor are preferably electrically connected in series.

By connecting the two rechargeable batteries in series, the voltage of a single battery can advantageously be doubled. This makes it much easier to achieve the desired rotation speed for the operation of the vibrating plate compactor. In addition, the preferred series connection of the two batteries can significantly reduce the electrical currents flowing within the vibrating plate compactor, so that thinner cables can be used. This can advantageously reduce the cabling effort and the resource outlay during the production of the vibrating plate compactor. It is preferred within the context of the invention that the two power supply devices of the vibrating plate compactor together have a voltage of substantially 44 V, in particular when the two rechargeable batteries are connected in series. In particular, the use of the series connection allows two small, compact power supply devices to be used within the vibrating plate compactor, which compensates for the use of a large battery of the type often used with conventional vibrating plate compactors from the prior art. The use of two rechargeable batteries also allows for a more flexible arrangement of the batteries within the drive unit of the vibrating plate compactor.

It is preferred within the context of the invention that the power supply devices used in the vibrating plate compactor can also be used in at least one power tool. This can advantageously provide a system consisting of a battery-powered vibrating plate compactor and a battery-powered power tool, wherein vibrating plate compactor and power tool can be operated with the same type of battery. In other words, the invention relates to a system consisting of a battery-powered vibrating plate compactor and a battery-powered power tool, wherein a power supply device is interchangeable in the sense that it can be used in both devices. Expressed another way, the vibrating plate compactor and the power tool can be supplied with electrical power using the same type of power supply device. This type of power supply device is preferably a battery such as is typically used in the field of construction site power tools. For the purposes of the invention, the term “construction site power tools” preferably refers to core drills, chipping hammers, hammer drills, cut-off saws or angle grinders or cordless screwdrivers, without being limited to these. In particular, the use of rechargeable batteries, which are also used in hammer drills or cordless screwdrivers, has proven to be particularly suitable for use in the vibrating plate compactor. Such construction site power tools, if they are battery-powered devices, can be connected to at least one power supply device to obtain electrical energy. Preferably, the batteries are suitable for use in both the vibrating plate compactor as well as in a construction site power tool. The power supply device is therefore compatible with a plurality of devices that can be used on a construction site.

In the context of the system, at least one vibrating plate compactor and at least one power tool can be operated with the same power supply device or the same battery type. In this case, the formulation “the same type” in the context of the invention preferably means that the batteries of a type are the same or identical in one feature or have the same or identical properties. For example, batteries of the same type may have an identical interface so that they can be connected together with devices that have the same mating structure for that interface. In addition, batteries of the same type may have the same or identical mechanical properties, such as volume, length, width or height, without being limited to these. For the purposes of the invention, it may also be preferred that batteries of the same type have the same or identical electrical properties. For example, batteries of the same type may have at least one of the following matching properties: capacity, charge quantity, current or voltage, without being limited to these. The power supply devices that are used to supply construction site power tools or in the system may have a capacity of, for example, less than 300 watt hours (Wh).

In a second aspect, the invention relates to a method for operating a vibrating plate compactor. The terms, definitions and technical advantages introduced for the vibrating plate compactor preferably apply analogously to the operating method for the vibrating plate compactor. The operating method is characterized in that the vibrating plate compactor has an electric motor, wherein the electric motor is operated in a speed range of more than 12,000 revolutions per minute.

It is preferred within the context of the invention that the vibrating plate compactor is connected to exactly two power supply devices in order to be supplied with electrical power. Preferably, the power supply devices can also be used in at least one power tool. An essential advantage of the invention is that a battery-powered soil compaction device or vibrating plate compactor can be provided, which can be operated with commercially available construction site rechargeable batteries, which are often already present on construction sites. This makes the power supply of various devices used on a construction site much easier and more efficient. In particular, the number of different types of batteries or power supply devices used can be reduced. This also means that fewer different chargers need to be kept on site, and power supply devices and batteries can be interchanged between different devices. For example, if a cordless screwdriver is not currently being used, the battery of the cordless screwdriver can be inserted in a vibrating plate compactor to smooth the ground, or vice versa. Such a simple replacement was not possible with conventional soil compaction devices and vibrating plate compactors known from the prior art, because the conventional soil compaction devices and vibrating plate compactors often had to be operated with special high-performance batteries with high powers and/or capacities. In contrast to this prior art, the vibrating plate compactor in the context of the present invention can be operated with conventional construction site or power tool batteries for which the infrastructure is usually already present on a construction site. No additional cables need to be laid on the construction site, nor do special chargers have to be provided for the power supply devices of the vibrating plate compactor.

In a further aspect, the invention relates to a system that comprises a battery-powered vibrating plate compactor and a battery-powered power tool. To be supplied with electrical power, the vibrating plate compactor is connected to at least one power supply device, wherein the at least one power supply device can also be used in the power tool.

Further advantages will become apparent from the following description of the figures. The figures, the description and the claims contain numerous features in combination. A person skilled in the art will expediently also consider the features individually and combine them to form sensible further combinations.

### BRIEF DESCRIPTION OF THE DRAWINGS

In the figures, identical and similar components are denoted by the same reference signs.

In the figures:

FIG. 1 shows a view of a preferred embodiment of the vibrating plate compactor, wherein to be supplied with power the vibrating plate compactor is connected to a power supply device

FIG. 2 shows a view of a preferred embodiment of the vibrating plate compactor, wherein to be supplied with power the vibrating plate compactor is connected to two power supply devices

FIG. 3 view of a preferred embodiment of the vibrating plate compactor with a horizontal arrangement of the components of the drive unit

### DETAILED DESCRIPTION

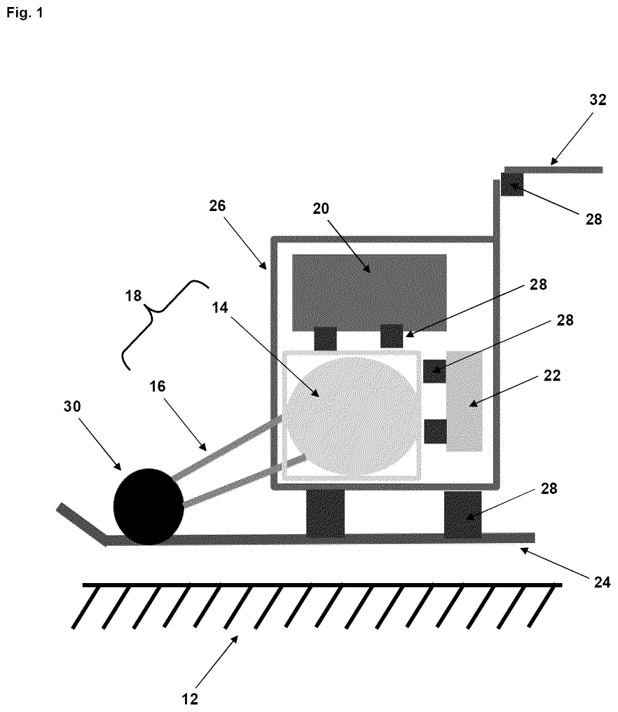

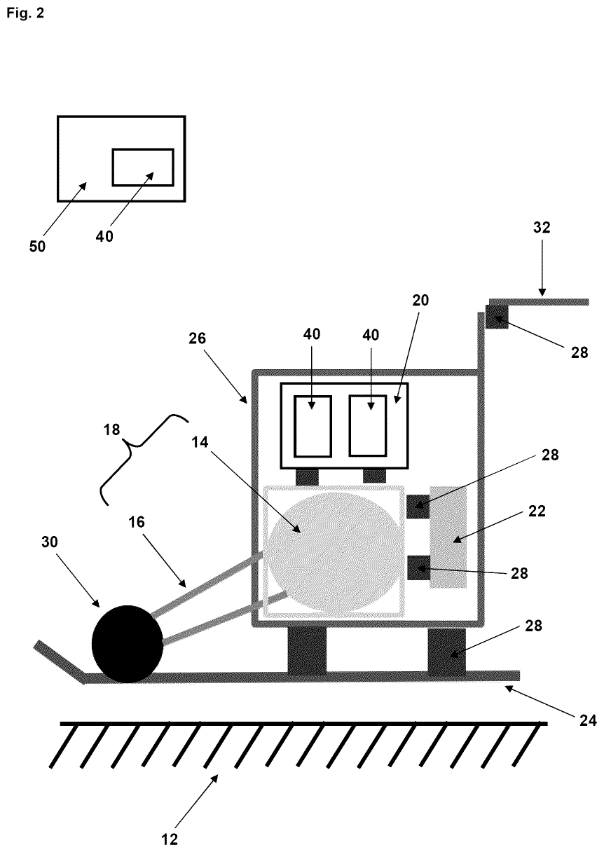

FIG. 1 shows a preferred embodiment of the vibrating plate compactor 10. The vibrating plate compactor 10 can be placed on a substrate 12, which is to be smoothed by a base plate 24 of the vibrating plate compactor 10. The base plate 24 of the vibrating plate compactor 10 can be excited to vibrations which can be used to compact the substrate 12. The vibrations or vibrational movements are generated by an electric motor 14 and transmitted to the base plate 24 by means of a transmission apparatus 16. The transmission apparatus 16 can be a spur gearing, for example. The transmission apparatus 16 and the electric motor 14 together form the power train 18 of the vibrating plate compactor 10. The movement of the electric motor 14 can preferably be transferred to a shaft, which in turn transfers the movement to the base plate 24. The shaft may comprise an eccentric mass 30 or be connected to an eccentric mass 30. The vibrating plate compactor 10 may be connected to at least one power supply unit 20 to obtain electrical power from the power supply device 20. In the exemplary embodiment of the invention shown in FIG. 1, the vibrating plate compactor 10 has a power supply device 20 in the form of an individual accumulator, while the vibrating plate compactor 10 shown in FIG. 2 has two individual accumulators 40, which together form the power supply unit 20. The power supply device 20, the electric motor 14 and a control electronics 22 together form a drive unit 26 of the vibrating plate compactor 10, which offers the advantage for the invention that it can be designed to be particularly easy-to-handle and compact. Thus, a vibrating plate compactor 10 with a particularly small transport size can be provided using the invention.

Damping elements 28 may be provided between a series of components of the vibrating plate compactor 10. For example, damping elements 28 may be provided between the base plate 24 and the drive unit 26. In addition, damping elements 28 may be provided between the at least one power supply unit 20 and/or the control electronics 22. The drive unit 26 may be connected to a handle or a push bar 32, with which the vibrating plate compactor 10 can be held or moved. Also, damping elements 28 can be provided between the drive unit 26 on one side and the handle or push bar 32 on the other side. These damping elements 28, for example, prevent the oscillations or vibrations of the vibrating plate compactor 10 or its base plate 24 from being transmitted to the user or his/her hands and joints. Another function of the damping elements 28 may be to protect individual sensitive elements of the vibrating plate compactor 10, such as the control electronics 22, from the vibrations and possible damage.

FIG. 2 shows a preferred embodiment of the vibrating plate compactor 10, which is connected to two power supply devices 40 in order to be supplied with electrical power. The two power supply devices 40 form the power supply unit 20 of the vibrating plate compactor 10. Schematically, FIG. 2 also shows a power tool 50 which is connected to a power supply device 40 of the same type in order to obtain electrical power. Thus, the system is to be presented, comprising a battery-powered power tool 50 and a battery-powered vibrating plate compactor 10, wherein both system components—vibrating plate compactor 10 and power tool 50—can be supplied with electrical power by power supply devices 40 of the same type. In this way, batteries 40 can be interchanged between the system components 10, 50 and the power supply for devices 10, 50 on a construction site can be considerably simplified. This is also true in particular because a uniform charging infrastructure can be used on the construction site. While the vibrating plate compactor 10 shown in FIG. 2 is supplied with electrical power by two power supply devices 40, for example, the power tool 50 shown schematically in FIG. 2 is connected to one power supply device 40. Of course, this division can also be reversed, so that the vibrating plate compactor 10 has one power supply device 40, while the power tool 50 is connected to two power supply devices 40 for the purpose of supplying power. Many other solutions are also conceivable.

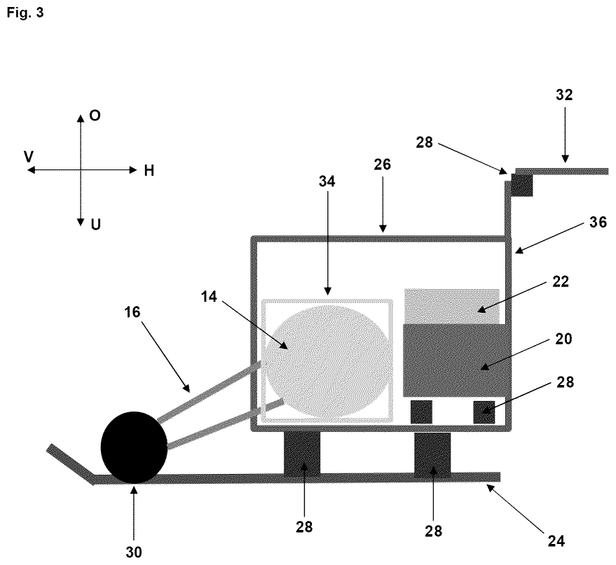

FIG. 3 shows a schematic side view of a possible embodiment of the vibrating plate compactor 10 with a horizontal arrangement of the components 14, 20, 22 of the drive unit 26. As shown in FIG. 3, the motor 14 of the vibrating plate compactor 10 is arranged in a front region of the drive unit 26, while the control electronics 22 and the power supply unit 20 form a unit (without reference sign), which is arranged behind the electric motor 14. In the exemplary embodiment of the invention illustrated in FIG. 3, the control electronics 22 is also arranged on an upper side of an illustrated power supply device 20. Thus, the motor 14 and the at least one power supply device 20, as “heavy” components of the drive unit 26 of the vibrating plate compactor 10, are arranged in a lower region of the drive unit 26. In this way, the center of gravity of the vibrating plate compactor 10 is particularly low, i.e. arranged particularly close to the substrate 12, which facilitates the handling of the vibrating plate compactor 10 and can improve the compaction result.

In FIG. 3, a frame 36 of the vibrating plate compactor 10 is also shown, as well as a motor housing 34, wherein the motor housing 34 surrounds the electric motor 14 of the vibrating plate compactor 10. Preferably, the drive unit 26 can also have a housing (without reference sign), which forms a spatial closure of the drive unit 26 relative to the surroundings. In addition, FIG. 3 shows the spatial directions O: upward, U: downward, H: rearward and V: forward. For example, the motor 14 is arranged in the drive unit 26 in front of the unit consisting of control electronics 22 and power supply unit 20, while, for example, the power supply unit 20 is arranged below the control electronics 22. Although the vibrating plate compactor 10 shown in FIG. 3 shows only one power supply unit 20, the vibrating plate compactor 10 may preferably have two or more power supply devices 40 in the form of individual accumulators. For the purposes of the invention, it is most particularly preferred that the vibrating plate compactor 10 has two individual accumulators 40, wherein the two individual accumulators 40 form the power supply unit 20 of the vibrating plate compactor 10. The individual accumulators 40 may be arranged side by side or one above the other in the drive unit 26. The individual accumulators 40 can be inserted into the drive unit 26 of the vibrating plate compactor 10, for example, from the rear, from above or from one side in order to supply the vibrating plate compactor 10 with electrical power.

### LIST OF REFERENCE SIGNS

10 Vibration plate
12 Soil, earth, substrate
14 Electric motor
16 Transmission apparatus, for example spur gearing
18 Power train
20 Power supply unit
22 Control electronics
24 Base plate
26 Drive unit
28 Damping elements
30 Eccentric mass
32 Handle or push bar
34 Motor housing
36 Frame
40 Individual accumulator
50 Power tool
O Spatial direction “upward”
U Spatial direction “downward”
V Spatial direction “forward”
H Spatial direction “rearward”

What is claimed is:

1. A vibrating plate compactor for compacting earth, soil or substrate, the vibrating plate compactor comprising:
an electric motor having an operable speed range of more than 12,000 revolutions per minute.

2. The vibrating plate compactor as recited in claim 1 further comprising a drive unit including the electric motor; control electronics; and a power supply unit connected to supply the electric motor with electrical power, wherein the control electronics or the power supply unit are arranged within the drive unit behind the electric motor.

3. The vibrating plate compactor as recited in claim 1 wherein the electric motor is a brushless DC motor.

4. The vibrating plate compactor as recited in claim 1 further comprising a power train following the electric motor, the power train including spur gearing.

5. The vibrating plate compactor as recited in claim 4 wherein the spur gearing is formed as a single stage.

6. The vibrating plate compactor as recited in claim 4 wherein the spur gearing has a transmission ratio in the range between 2.5 and 6.

7. The vibrating plate compactor as recited in claim 1 wherein in order to be supplied with power, the vibrating plate compactor is connectable to at least one power supply device.

8. The vibrating plate compactor as recited in claim 7 wherein the at least one power supply device includes two power supply devices.

9. The vibrating plate compactor as recited in claim 8 wherein the two power supply devices are connected in series.

10. The vibrating plate compactor as recited in claim 7 wherein the at least one power supply device can also power at least one power tool.

11. The vibrating plate compactor as recited in claim 7 wherein the at least one power supply device has a capacity of less than 300 Watt hours.

12. A method for operating the vibrating plate compactor as recited in claim 1, the method comprising operating the electric motor in a speed range of more than 12,000 revolutions per minute.

13. The method as recited in claim 12 wherein the vibrating plate compactor is connected to two power supply devices for supplying electrical power.

14. A system comprising the vibrating plate compactor as recited in claim 1 and a power tool powered by a rechargeable battery, wherein in order to be supplied with electrical power, the vibrating plate compactor is connected to at least one power supply device, wherein the at least one power supply device also is usable in the power tool.

15. The system as recited in claim 14 wherein the at least one power supply device has a capacity of less than 300 Watt hours.
